(19) United States
(12) Patent Application Publication
(10) Pub. No.: US 2014/0203082 A1
(43) Pub. Date: Jul. 24, 2014

(54) CARD READER DEVICE USING A MOBILE, AND THE METHOD THEREOF

(71) Applicant: Inghoo Huh, Seoul (KR)

(72) Inventor: Inghoo Huh, Seoul (KR)

(73) Assignee: DAURI SOLUTION CO., LTD., Seoul (KR)

(21) Appl. No.: 14/239,622

(22) PCT Filed: Aug. 20, 2012
(86) PCT No.: PCT/KR2012/006611

§ 371 Date: Feb. 19, 2014

(30) Foreign Application Priority Data
Aug. 20, 2011 (KR) 10-2011-0083168

(51) Int. Cl. G06K 7/00; G06K 7/01; G06K 7/08

(52) U.S. Cl. CPC G06K 7/0004; G06K 7/082; G06K 7/089; G06K 7/01
USPC 235/440; 235/439; 235/449

(57) ABSTRACT

A card reader device using a mobile and the method thereof is introduced. The mobile is adopted to supply electric power through audio output jack, and to transmit card data applied from the card reader device via microphone input jack. The card reader unit is connected to the audio jack of the mobile, and offers card data read by the card reader units via microphone input of the mobile. The card reader device comprises a contact type card reader unit to read cards with magnetic strips, and a contactless type card reader unit for contactless smart cards. The card reader device of the present invention enables and simplifies card transaction through mobile devices, and the reader is combinable with any mobiles with audio jack only.

### TECHNICAL FIELD

A card reader device using a mobile and the method thereof is introduced. The mobile is adopted to supply electric power through audio output jack, and to transmit card data applied from the card reader device via microphone input jack. The card reader unit is connected to the audio jack of the mobile, and offers card data read by the card reader units via microphone input of the mobile.

The card reader device comprises a contact type card reader unit to read cards with magnetic strips, and a contactless type card reader unit for contactless smart cards.

The card reader device of the present invention enables and simplifies card transaction through mobile devices, and the reader is combinable with any mobiles with audio jack only.

### BACKGROUND ackground Art

Contact type cards with magnetic strips, and contactless type cards to transmit internal data while exited by induced magnetic field from antenna coil of readers are widely used in the field of financial transaction such as credit cards or debit cards. For the convenience of transaction to overcome limitations in transaction process using the conventional online terminals connected to communication lines, and to add mobility to transaction terminals, card readers combinable to mobile terminals are introduced in the field.

One of the disclosed prior art of present invention is KR 10-1021264 B1, a mobile PCI(Payment Card Industry) POS terminal and control method thereof, shown in the FIG. 1. To secure a PCI reliability by inputting PIN number only through a display and a keypad of a PIN entry device unit, tampers are formed on each outer sides of a upper/lower PCBs, and a safety film exposes the tempers and dome switches. A rubber pad covers the upper sides of the dome switches, and a plurality of tamper contacts is attached to the rubber pad. Lower tamper contracts turns on the tampers by touching the tampers.

In this type of mobile PCI POS terminal, the PIN entry device unit of card reader is constructed to be connected to the POS terminal through communication connector however, it causes limitation in applications for users because the communication connectors may be prepared in different types and shapes according to the communication connectors of mobiles to be used.

Another disclosed prior art of present invention is JP 2009-277106 A, shown in FIG. 2. The background art directs to noncontact card, method for controlling it, and mobile information terminal to allow a function of a noncontact IC card to be switchable between business use and private use. In this art, the noncontact IC card includes a hardware section and a software section for a noncontact IC card. The software section includes a control region, a first region for private use, a second region for corporate use, and a common region. When the noncontact IC card is held over an IC card reader of a company to register a report to work, the control region activates the second region for corporate use and deactivates the first region for private use. On the other hand, when a check-out is registered by the IC card reader of the company, the control region deactivates the second region for corporate use and activates the first region for private use

For the application of this technology, a dedicated mobile information terminal equipped with noncontact IC card reader is necessary, while general users can not arrange mobile circuit inside for the application.

The other disclosed prior art of present invention is WO 2010/111130 A2, shown in FIG. 3. The background art directs to audio/acoustically coupled card reader comprising an audio/acoustically coupled card reader, a mobile communication device, an interface server and a payment card processor. The audio/acoustically coupled card reader includes means for reading payment card data from a payment card, means for generating a stream of audio/acoustical signals comprising the payment card data and means for transmitting the stream of audio/acoustical signals. The mobile communication device includes means for receiving the stream of audio/acoustical signals, means for generating an electrical signal comprising data contained in the stream of audio/acoustical signals and means for transmitting the electrical signal. The interface server includes means for extracting the payment card data from the electrical signal and means for transmitting the payment card data. The mobile communication device connects to the interface server device via a first network and transmits the electrical signal to the interface server. The interface server connects to the payment card processor via a second network and transmits the payment card data to the payment card processor for payment processing. The payment card processor processes payments via payment card companies.

This type of card reader lacks data security function to transmit data between card reader and a mobile communication device by sound, and causes relatively higher error rate of data transmission when in acoustically noisy environment.

The other disclosed prior arts of present invention are U.S. Pat. No. 7,810,729 B2, and U.S. Pat. No. 7,918,394 B1, shown in the FIG. 4. The arts relate to card reader device for a cell phone and method of use wherein, the card reader device comprises a read head for passing a magnetic stripe of a card by to read data stored on a magnetic stripe and for producing a signal indicative of data stored on a magnetic stripe, a signal setting device for setting an amplitude of the signal indicative of data stored on a magnetic stripe, and an output jack adapted to be inserted into a microphone input associated with a cell phone for providing the signal indicative of data stored on a magnetic stripe to a cell phone. Data stored on the card and sensed by the card reader device is decoded by components such as a microphone amplifier, an analog to digital converter, and a microprocessor already resident in a cell phone.

The card reader of this prior art is only limited to contact type card with magnetic strip, which is not possible to access contactless type, and since this prior art basically adopts passive type reader, external power means with additional wiring for active type card reader arrangement.

### DISCLOSURE OF INVENTION

### Technical Problem

The present invention is to solve the technical problems of prior arts, to provide a card reader device using a mobile and the method thereof using any mobiles with audio jacks.

The present invention also provides a card reader device using a mobile and the method thereof, capable of accessing both of contact type cards and contactless type cards without additional external power supply units.

### Solution to Problem

Exemplary embodiments overcome the above disadvantages and other disadvantages not described above. However, it is understood that an exemplary embodiment is not required to overcome the disadvantages described above, and an exemplary embodiment may not overcome any of the problems described above.

Exemplary embodiments of present invention provide a card reader device using a mobile and the method thereof. The mobile is adopted to supply electric power through audio output jack, and to transmit card data applied from the card reader device via microphone input jack. The card reader unit is connected to the audio jack of the mobile, and offers card data read by the card reader units via microphone input of the mobile.

The card reader device comprises a contact type card reader unit to read cards with magnetic strips, and a contactless type card reader unit for contactless smart cards. Advantageous Effects of Invention

According to the present invention, a data secured card reader device can be realized with less of difficulties for users only using audio jack of a mobile. Also the present invention offers advantageous effects to offer a card reader to process contact and contactless type cards, combined with mobiles without additional power units.

### BRIEF DESCRIPTION OF DRAWINGS

FIG. 1 is structure of the first prior art of present invention

FIG. 2 is structure of the second prior art of present invention

FIG. 3 is structure of the third prior art of present invention

FIG. 4 is structure of the forth prior art of present invention

FIG. 5 is the scheme of the present invention

FIG. 6 shows data structure of contact type card with magnetic strip

FIG. 7 shows an example of contactless type card with IC(integrated circuit), and the reader unit construction

FIG. 8 shows block diagram of mobile for the present invention

FIG. 9 shows the first embodiment of card reader unit of present invention

FIG. 10 shows the second embodiment of card reader unit of present invention

FIG. 11 shows the third embodiment of card reader unit of present invention

FIG. 12 shows an example of power supply unit of card reader unit

FIG. 13 shows examples of active summing unit and passive summing unit

FIG. 14 shows an example of realized card reader device using a mobile of the present invention

FIG. 15 is a flow chart of operating method for card reader device using a mobile of present invention at mobile side

FIG. 16 is a flow chart of operating method for card reader device using a mobile of present invention at card reader unit side

FIG. 17 is a flow chart of another operating method for card reader device using a mobile of present invention at mobile side

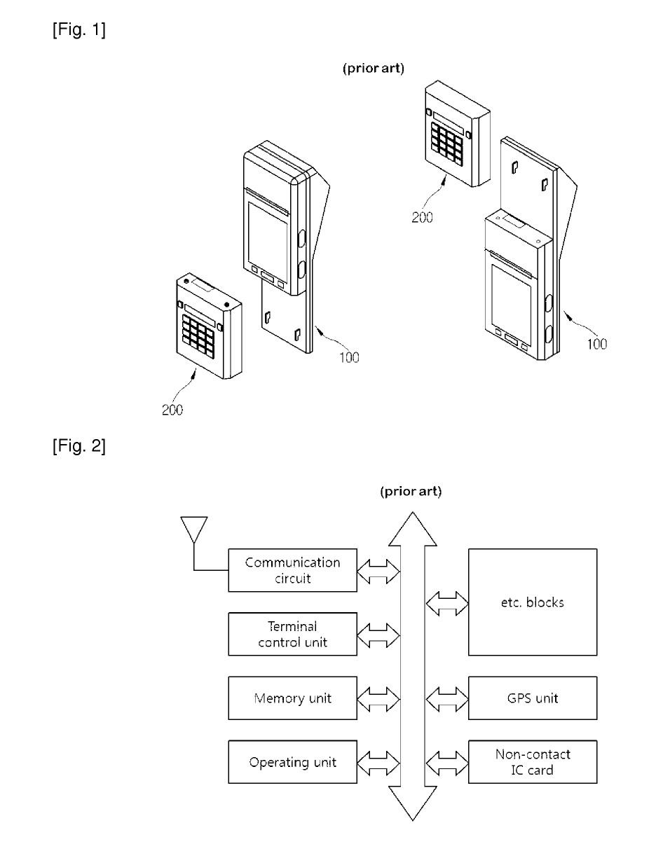

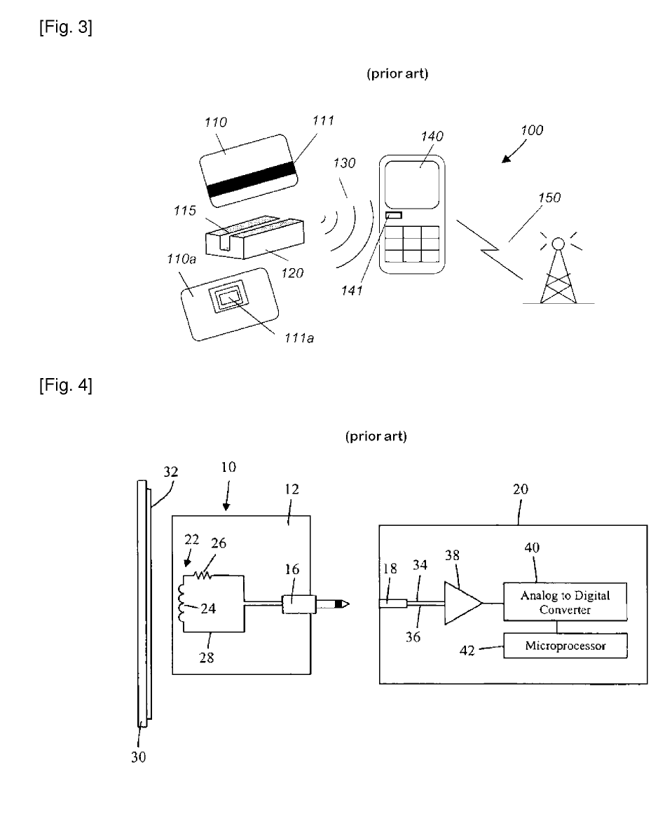

### BEST MODE FOR CARRYING OUT THE INVENTION

The present invention provides a card reader device comprising; a mobile providing audio signal as electric power through earphone output of audio jack, to transmit card data extracted from the signal offered by card reader unit through microphone input of audio jack, a card reader unit connected to the audio jack(of mobile, while the card reader unit comprises contact type card reader unit to read contact type card with magnetic strip, and contactless type card reader unit to read contactless type cards such as IC cards, and the said card reader unit is powered by audio signal from the mobile, and card data read is transmitted via microphone input of audio jack.

### Mode for the Invention

The principles of the present invention will be shown hereinafter. Hence, although not shown or not clearly described, it should be understood by one of ordinary skill in the art that the principles of the present invention can be embodied and various devices included within the concept and scope of the present invention can be invented. Also, it should be understood that all terms and embodiments enumerated in the specification are only intended to explain the concept of the present invention and the present invention is not limited to the embodiments and states. Also, it should be understood that all detailed description of the exemplary embodiments is intended to include not only the principles, the aspects, and the exemplary embodiments of the present invention but also structural and functional equivalents thereof. Also, it should be understood that the equivalents include not only currently publicized equivalents but also equivalents to be developed in the future, that is, all devices to be developed to perform the same function irrespective of their structures. Functions of various devices that are illustrated in drawings including a function block denoted as a controller or as a similar concept to the controller, can be provided not only with specific hardware but also general hardware in which related software can be executed. When these functions are provided by the controller, the functions may be provided by a singular specific processor, a singular sharable processor, or plural processors in which sharing between the plural processors is possible. Also, usage of terms such as a controller, a control, or the like should not be construed as being limited to hardware capable of executing software but should be construed as indirectly including digital signal processor (DSP) hardware, read-only memory (ROM), random-access memory (RAM), and non-volatile memory used for storing software. Other well-known conventional hardware devices may be included.

Hereinafter, the present invention will be described in detail by explaining exemplary embodiments of the invention with reference to the attached drawings. Detailed explanation will not be given when it is determined that detailed explanation about well-known function and configuration of the present invention may dilute the point of the present invention. The present invention will now be described more fully with reference to the accompanying drawings, in which exemplary embodiments of the invention are shown.

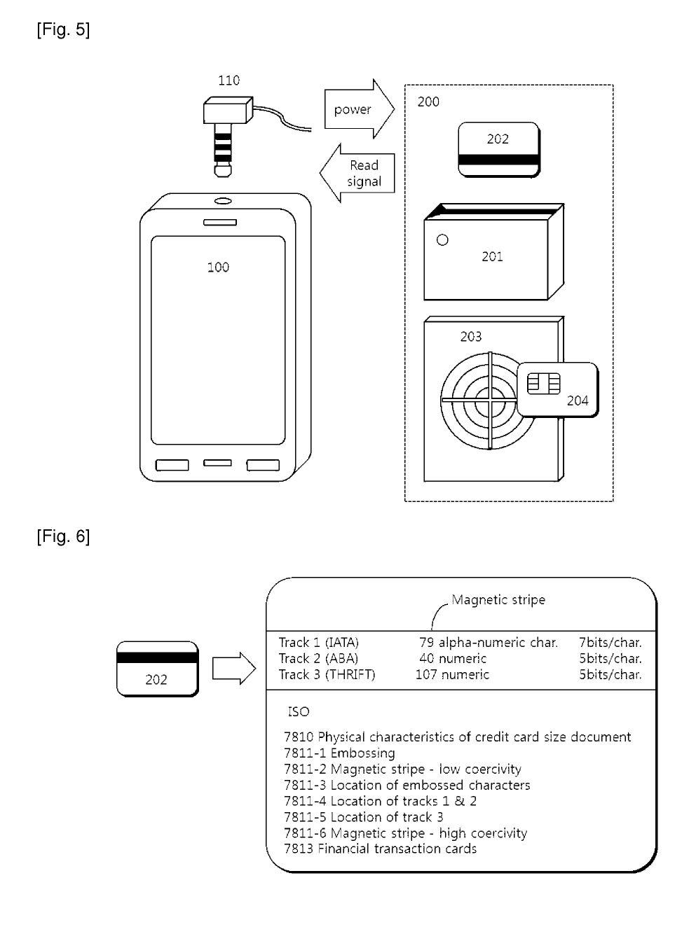

FIG. 5 shows scheme of the present invention. The present invention specifies a mobile(100) providing audio signal as electric power through earphone output of audio jack(110), to transmit card data extracted from the signal offered by card reader unit(200) through microphone input of audio jack(110). The card reader unit(200) is connected to the audio jack(110) of mobile(100). The card reader unit(200) comprises contact type card reader unit(201) to read contact type card(202) with magnetic strip, and contactless type card reader unit(203) to read contactless type cards such as IC cards. The card reader unit(200) is powered by audio signal from the mobile(100), and card data read is transmitted via microphone input of audio jack(110).

FIG. 6 shows data structure of contact type card with magnetic strip. The specification of contact type card(202) is defined as international standards by ISO(International Standard Organization), as ISO 7810, ISO 7811, ISO 7813, etc. According to data structure in magnetic strip of contact type cards, it uses three of IATA, ABA, Thrift tracks as shown in the FIG. 6. As for credit card applications, the data in the first track(IATA) of magnetic strip is used, and the data in the second track(ABA) is mostly for financial institutes such as banks. Referring to the FIG. 6, whole bit size of each track is 553 bits for track 1, 200 bits for track 2, 535 bits for track 3, respectively. The data on those tracks can be detected as audible voice signals(−4 KHz), when read moving over a magnetic head. For example, the said magnetic trip is moved over a magnetic head for 0.5 second, the data rate of each track is 1,106 bits/sec, 400 bits/sec, and 1,070 bits/sec, respectively as detectable voice band signals.

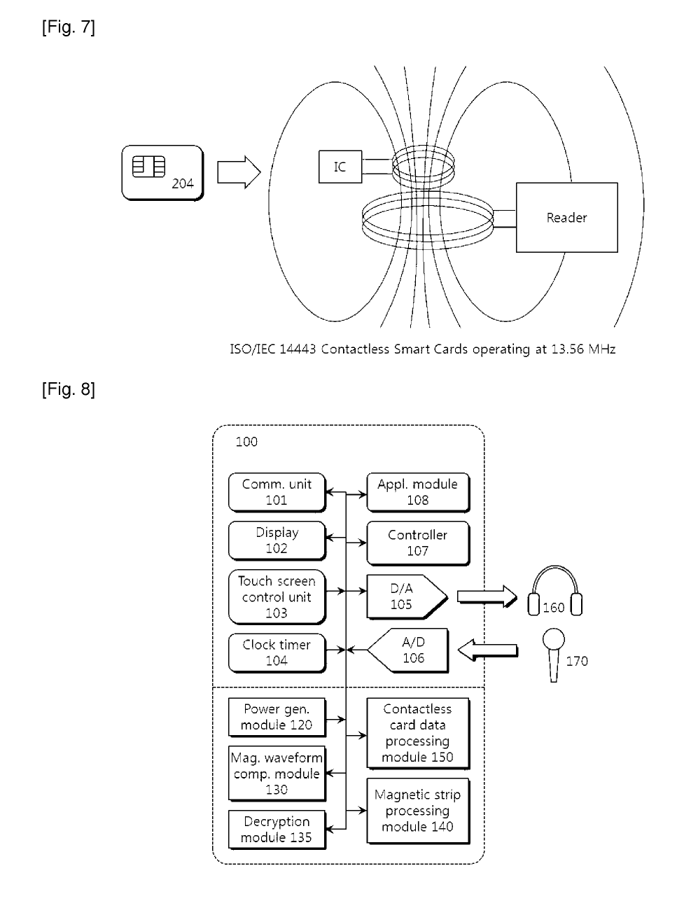

FIG. 7 shows an example of contactless type card(204) with IC(integrated circuit), and the reader unit construction. Conventional contactless type card(204) comprises IC(integrated circuit) and antenna coil inside, which are excited(ie. powered) by magnetic field induced from the antenna coil of reader unit to transmit data stored in the IC—then the reader unit picks up the data without mechanical contact. The antenna coil of the reader unit is driven to provide alternating magnetic field to the card, and also to receive data transmitted from the contactless type card(204). One of the widely used contactless type card(204) is specified in ISO/IEC 14443 RFID(Radio Frequency IDentification). According to the specification from the standard, the frequency from the antenna coil of the reader unit to excite card is 13.56 MHz, carrier frequency of data from the contactless type card(204) is 847.5 KHz which is 1/16 of 13.56 MHz, data rate is 106 Kbit/sec. Thus it is impossible to access data from contactless type card(204) directly on voice band units, present invention provides specified means and method to overcome the limitations of contactless type card(204) processing.

FIG. 8 shows block diagram of mobile for the present invention. From the followings, the structure of mobile(100) is explained in two groups; conventional elements and the elements specified in the present invention.

The mobile of present invention comprises conventional elements shown in the upper side of dotted line of the figure; communication unit(101), display unit(102), touch screen control unit(103), clock timer(104), D/A converting unit(105), A/D converting unit(106), controller(107), application module(108).

Communication unit(101) transmits and receives voice and data under the control of controller(107), display unit(102) displays information and data provided from the controller(107). Touch screen control unit(103) is prepared over display unit(102) and provides touch screen input to the controller(107). Clock timer(104) counts time as set by the controller(107). D/A converting unit(105) converts voice or audio data received by communication unit(101) into analog signal, then provides to speaker unit inside of mobile(100) or external earphone jack(160) of audio jack.

A/D converting unit(106) converts signals from microphone inside the mobile(100) or external microphone jack(170), into digital data to provide to the controller(107). The controller(107) executes program stored in the application module(108) to transmit data from A/D converting unit(106) via communication unit(101), or performs internal process. Application module(108) stores application programs for the mobile(100), and controller(107) executes program selected by user from the ap-plication module(108).

The mobile of present invention more comprises specified elements shown in the lower side of dotted line of the figure; power generating module(120), magnetic waveform compensation module(130), decryption module(135), magnetic strip data processing module(140), contactless card data processing module(150).
Power generating module(120) generates audio signal of constant frequency and amplitude and outputs via earphone jack(160) through D/A converting unit(105), under the control from the controller(107). A preferable audio signal frequency can be selected between 100 Hz˜4 KHz, and amplitude can be set more than 10% of maximum amplitude of power generating module(120) used.
Magnetic waveform compensation module(130) compensates waveform, converted signal from the microphone jack(170) by A/D converting unit(106), into logic level data. Magnetic waveform compensation module(130) can be designed to adopt Schmitt-trigger method, or eye-let processing comparing inverted and non-inverted signals.
Decryption module(135) extracts card data from the data from the microphone jack(170) by A/D converting unit(106), which is encrypted by card reader unit(200).
Magnetic strip data processing module(140) converts contact type card data from magnetic waveform compensation module(130) or decryption module(135), into ISO standard format or that of card transaction service institute such as banks, then provides to controller(107).
Contactless card data processing module(150) converts contactless type card data from decryption module(135), into ISO standard format or that of card transaction service institute such as banks, then provides to controller(107).

Thus the mobile(100) of present invention outputs audio signal of constant frequency and amplitude via earphone jack(160) as electrical power for card reader unit(200), then converts contact and contactless type card data from microphone jack(170) into ISO standard format or that of card transaction service institute such as banks, then provides to controller(107). The controller(107) transmits card data through communication unit(101), and communicates with card transaction service institutes.

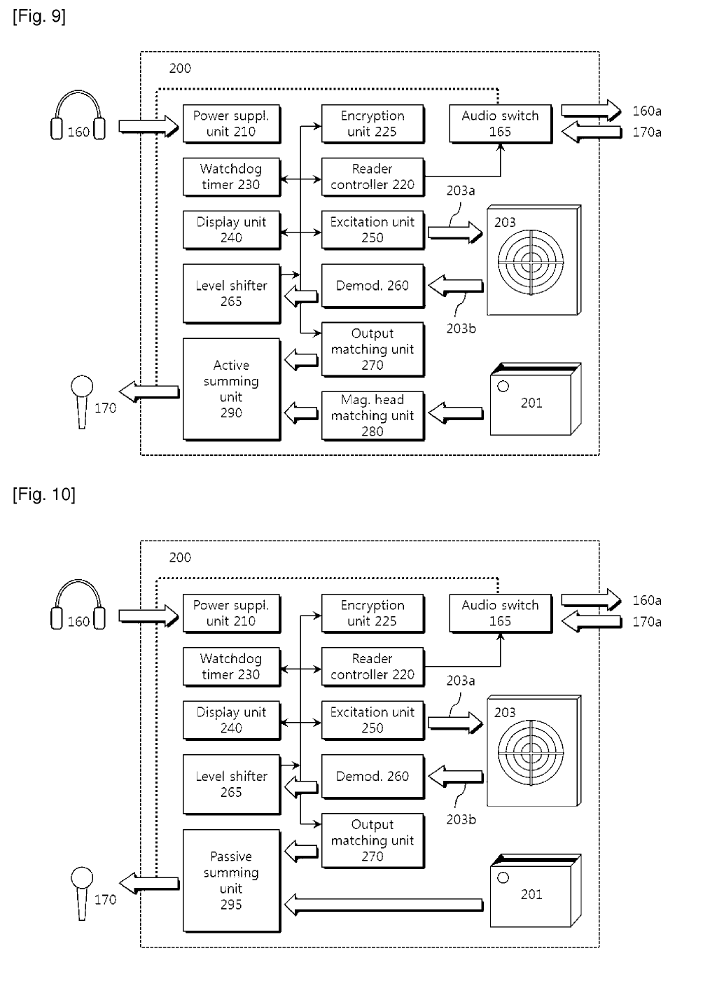

FIG. 9 shows the first embodiment of card reader unit of present invention. The card reader unit(200) of present invention is connected to mobile(100) via audio jack(110) with earphone jack(160) and microphone jack(170). In FIG. 9, power connections from power supply unit(210) to each of other elements are omitted to clarify the structure of present invention.
Power supply unit(210) converts audio signal of constant frequency and amplitude provided via earphone jack(160) of mobile(100) into dc power, and supplies to each elements of card reader unit(200).
Encryption unit(225) encrypts card data provided from reader controller(220) of card reader unit(200).
Watchdog timer(230) counts time set by reader controller(220). This watchdog timer(230) is referred by reader controller(220) to process error or to end process, when card data is not read within the time set for reading a card.
Display unit(240) displays operation status of card reader unit(200). Display unit(240) can be prepared with LEDs turned on by power from power supply unit(210), or a plurality of lighting means driven by the output from reader controller(220).
Excitation unit(250) generates and provides exciting signal(203a) to antenna coil of contactless reader unit(203), under the control of reader controller(220). For contactless card(204) of ISO/IEC 14443 RFID(Radio Frequency IDentification), the exciting signal(203a) is at the frequency of 13.56 MHz.
Demodulation unit(260) demodulates data carrier signal(203b) received by antenna of contactless type card reader(203), which is transmitted from contactless type card(204) excited by excitation signal(203a) from excitation unit(250). For the said contactless type card(204) of ISO/IEC 14443 RFID specification, data carrier signal is of 847.5 KHz, demodulated data rate is 106 Kbit/sec.
Level shifter(265) comprises analog input and digital output. Level shifter(265) changes input analog signal into logic level output to be read by reader controller(220), and comparator circuit or Schmitt-trigger circuit can be adopted for the function.
Output matching unit(270) basically attenuates data signal from reader controller(220) to provide to microphone jack(170) of mobile(100). The output matching unit(270) comprises digital input from reader controller(220) and analog output to microphone jack(170) of mobile(100).
Magnetic head matching unit(280) attenuates or amplifies level of signal from contact type card reader unit(201) to provide to microphone jack(170) of mobile(100). The degree of attenuation or amplification is decided according to the characteristic of magnetic head of contact type reader unit(201).
Active summing unit(290) is a summing amplifier to add signals from output matching unit(270) and magnetic head matching unit(280), to provide added signals to microphone jack(170) of mobile(100).
Card reader unit(200) of present invention, provides extended earphone jack(160a) and extended microphone jack(170a) for external audio connection, since audio jack(110) of mobile(100) is connected for internal access of card reader unit(200). The said extended earphone jack(160a) and extended microphone jack(170a) should be disconnected while card reader unit(200) is operating. Hence card reader unit(200) of present invention comprises audio switch(165) with earphone jack(160) and microphone jack(170) inputs, and extended earphone jack(160a) and extended microphone jack(170a) outputs. When card reader unit(200) is not operating as card reader, reader controller(220) connects earphone jack(160) to extended earphone jack(160a) and microphone jack(170) to extended microphone jack(170a) through audio switch(165). When card reader unit(200) is operating as card reader, reader controller(220) disconnects extended earphone jack(160a) from earphone jack(160) and extended microphone jack(170a) from microphone jack(170) through audio switch(165).

FIG. 10 shows the second embodiment of card reader unit of present invention. The second embodiment of card reader unit of present invention differs from head matching unit(280) and active summing unit(290) of the first embodiment of present invention. The second embodiment of card reader unit of present invention comprises; the signal from magnetic head of contact type card reader unit(201) is directly connected to passive summing unit(295), the passive summing unit(295) adds the read signal from contact type card reader unit(201) and the signal from output matching unit. The second embodiment of card reader unit of present invention enables reading contact type card without supplying audio signal of constant frequency and amplitude provided via earphone jack(160) of mobile(100) to activate power supply unit(210) of card reader unit(200).
Power supply unit(210) converts audio signal of constant frequency and amplitude provided via earphone jack(160) of mobile(100) into dc power, and supplies to each elements of card reader unit(200), only when to read contactless card(204). For reading contact type card, mobile(100) is not needed to supply audio signal of constant frequency and amplitude via earphone jack(160) for power supply unit(210).
Encryption unit(225) encrypts card data provided from reader controller(220) of card reader unit(200) when to read contactless card(204) only.
Watchdog timer(230) counts time set by reader controller(220). This watchdog timer(230) is referred by reader controller(220) to process error or to end process, when card data is not read within the time set for reading a contactless card.
Display unit(240) displays operation status of card reader unit(200). Display unit(240) can be prepared with LEDs turned on by power from power supply unit(210), or a plurality of lighting means driven by the output from reader controller(220) for reading a contactless card.
Excitation unit(250) generates and provides exciting signal(203a) to antenna coil of contactless reader unit(203), under the control of reader controller(220). For contactless card(204) of ISO/IEC 14443 RFID(Radio Frequency IDentification), the exciting signal(203a) is at the frequency of 13.56 MHz.
Demodulation unit(260) demodulates data carrier signal(203b) received by antenna of contactless type card reader(203), which is transmitted from contactless type card(204) excited by excitation signal(203a) from excitation unit(250). For the said contactless type card(204) of ISO/IEC 14443 RFID specification, data carrier signal is of 847.5 KHz, demodulated data rate is 106 Kbit/sec.
Level shifter(265) comprises analog input and digital output. Level shifter(265) changes input analog signal into logic level output to be read by reader controller(220), and comparator circuit or Schmitt-trigger circuit can be adopted for the function for reading a contactless card.
Output matching unit(270) basically attenuates data signal from reader controller(220) to provide to microphone jack(170) of mobile(100). The output matching unit(270) comprises digital input from reader controller(220) and analog output to microphone jack(170) of mobile(100).
Passive summing unit(295) is a passive summing circuit to add signals from output matching unit(270) and contact type card reader unit(201), to provide added signals to microphone jack(170) of mobile(100).
Card reader unit(200) of present invention, provides extended earphone jack(160a) and extended microphone jack(170a) for external audio connection, since audio jack(110) of mobile(100) is connected for internal access of card reader unit(200). The said extended earphone jack(160a) and extended microphone jack(170a) should be disconnected while card reader unit(200) is reading contactless type cards. Hence card reader unit(200) of present invention comprises audio switch(165) with earphone jack(160) and microphone jack(170) inputs, and extended earphone jack(160a) and extended microphone jack(170a) outputs. When card reader unit(200) is not operating as contactless type card reader, reader controller(220) connects earphone jack(160) to extended earphone jack(160a) and microphone jack(170) to extended microphone jack(170a) through audio switch(165). When card reader unit(200) is operating as contactless type card reader, reader controller(220) disconnects extended earphone jack(160a) from earphone jack(160) and extended microphone jack(170a) from microphone jack(170) through audio switch(165).

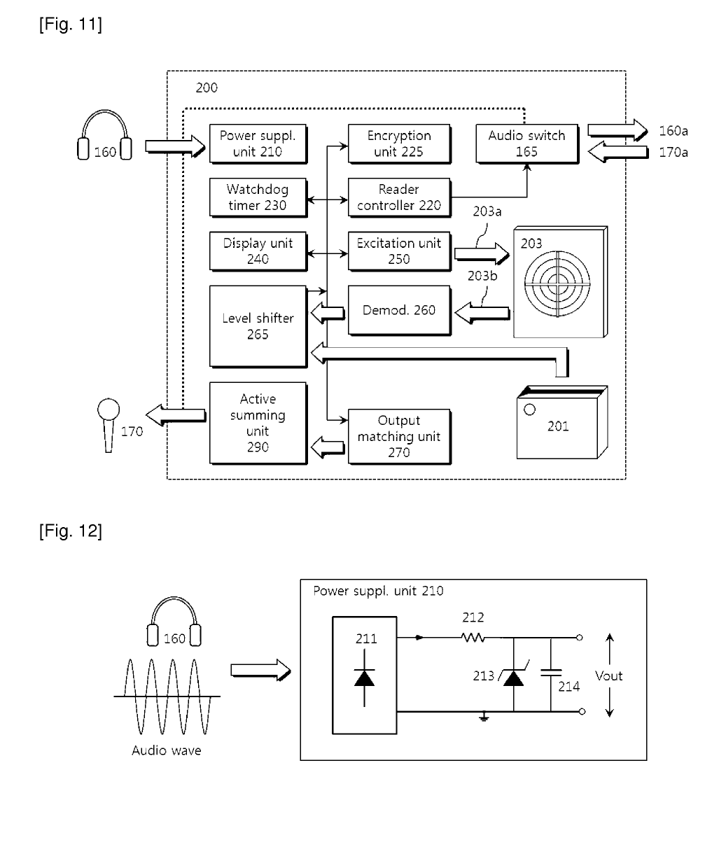

FIG. 11 shows the third embodiment of card reader unit of present invention. The third embodiment of card reader unit of present invention differs from the first embodiment of present invention in that the signal from magnetic head of contact type card reader unit(201) is directly connected to level shifter(265), and output from card reader unit(200) is provided to microphone jack(170) of mobile(100) via output matching unit(270).

The third embodiment of card reader unit of present invention enables card data read from contact type card reader unit(201) to be encrypted by reader controller(220) through encryption unit(225).
Power supply unit(210) converts audio signal of constant frequency and amplitude provided via earphone jack(160) of mobile(100) into dc power, and supplies to each elements of card reader unit(200).
Encryption unit(225) encrypts card data provided from reader controller(220) of card reader unit(200) when to read both of contactless type card(204) and contact type card(202).
Watchdog timer(230) counts time set by reader controller(220). This watchdog timer(230) is referred by reader controller(220) to process error or to end process, when card data is not read within the time set for reading a card.
Display unit(240) displays operation status of card reader unit(200). Display unit(240) can be prepared with LEDs turned on by power from power supply unit(210), or a plurality of lighting means driven by the output from reader controller(220) for reading a contactless card.
Excitation unit(250) generates and provides exciting signal(203a) to antenna coil of contactless reader unit(203) for contactless type card(204), under the control of reader controller(220). For contactless card(204) of ISO/IEC 14443 RFID(Radio Frequency IDentification), the exciting signal(203a) is at the frequency of 13.56 MHz.
Demodulation unit(260) demodulates data carrier signal(203b) received by antenna of contactless type card reader(203), which is transmitted from contactless type card(204) excited by excitation signal(203a) from excitation unit(250). For the said contactless type card(204) of ISO/IEC 14443 RFID specification, data carrier sigal is of 847.5 KHz, demodulated data rate is 106 Kbit/sec.
Level shifter(265) comprises analog input and digital output. Level shifter(265) changes input analog signal into logic level output to be read by reader controller(220), and comparator circuit or Schmitt-trigger circuit can be adopted for the function for reading a contactless card.
Output matching unit(270) basically attenuates data signal from reader controller(220) to provide to microphone jack(170) of mobile(100). The output matching unit(270) comprises digital input from reader controller(220) and analog output to microphone jack(170) of mobile(100).
Card reader unit(200) of present invention, provides extended earphone jack(160a) and extended microphone jack(170a) for external audio connection, since audio jack(110) of mobile(100) is connected for internal access of card reader unit(200). The said extended earphone jack(160a) and extended microphone jack(170a) should be disconnected while card reader unit(200) is reading contactless type cards. Hence card reader unit(200) of present invention comprises audio switch(165) with earphone jack(160) and microphone jack(170) inputs, and extended earphone jack(160a) and extended microphone jack(170a) outputs. When card reader unit(200) is not operating as card reader, reader controller(220) connects earphone jack(160) to extended earphone jack(160a) and microphone jack(170) to extended microphone jack(170a) through audio switch(165). When card reader unit(200) is operating as card reader, reader controller(220) disconnects extended earphone jack(160a) from earphone jack(160) and extended microphone jack(170a) from microphone jack(170) through audio switch(165).

The card readers shown in FIG. 9 to FIG. 11, can be operated in four modes—active contactless type card reader mode, active contact type card reader mode 1, active contact type card reader mode 2, and passive contact type card reader mode. The followings are the sequence of each operation modes of card readers of present invention.

(1) Active Contactless Type Card Reader Mode
Audio signal of constant frequency and amplitude is provided via earphone jack(160) of mobile(100) into power supply unit(210) of card reader unit(200). The power supply unit(210) converts the audio signal into dc power, and supplies to each elements of card reader unit(200).
Reader controller(220) activates excitation unit(250) to generate and to provide exciting signal(203a) to antenna coil of contactless reader unit(203).
Demodulation unit(260) demodulates data carrier signal(203b) received by antenna of contactless type card reader(203), which is transmitted from contactless type card(204) excited by excitation signal(203a) from excitation unit(250).
Level shifter(265) changes input analog signal from demodulation unit(260) into logic level output to be read by reader controller(220).
Reader controller(220) encrypts card data provided from level shifter(265) through encryption unit(225).
Reader controller(220) provides encrypted card data to output matching unit(270) as read data signal to microphone jack(170) of mobile(100). In this case, the data rate of the said encrypted card data must be lowered to voice frequency by reader controller(220), since data rate of ISO/IEC 14443 RFID standard contactless type card is 106 Kbit/sec. Preferably lowered data rate of said encrypted card data is 100˜2,000 bits/sec.
Output matching unit(270) attenuates encrypted card data signal from reader controller(220) to provide to microphone jack(170) of mobile(100).
The output of said output matching unit(270) is provided to microphone jack(170) of mobile(100), in one of following three ways;
The signal from said output matching unit(270) is provided to active summing unit(290), and then provided to microphone jack(170) of mobile(100).
The signal from said output matching unit(270) is provided to passive summing unit(295), and then provided to microphone jack(170) of mobile(100).
The signal from said output matching unit(270) is directly provided to microphone jack(170) of mobile(100).

(2) Active Contact Type Card Reader Mode 1
Audio signal of constant frequency and amplitude is provided via earphone jack(160) of mobile(100) into power supply unit(210) of card reader unit(200). The power supply unit(210) converts the audio signal into dc power, and supplies to each elements of card reader unit(200).
Magnetic head matching unit(280) attenuates or amplifies level of signal from contact type card reader unit(201) to provide to microphone jack(170) of mobile(100). The degree of attenuation or amplification is decided according to the characteristic of magnetic head of contact type reader unit(201).
Active summing unit(290) provides signal from magnetic head matching unit(280) to microphone jack(170) of mobile(100).

(3) Active Contact Type Card Reader Mode 2
Audio signal of constant frequency and amplitude is provided via earphone jack(160) of mobile(100) into power supply unit(210) of card reader unit(200). The power supply unit(210) converts the audio signal into dc power, and supplies to each elements of card reader unit(200).
Level shifter(265) changes input analog signal from contact type card reader unit(201) into logic level output to be read by reader controller(220).
Reader controller(220) encrypts card data provided from level shifter(265) through encryption unit(225).
Reader controller(220) provides encrypted card data to output matching unit(270) as read data signal to microphone jack(170) of mobile(100).

(4) Passive Contact Type Card Reader Mode
In passive contact type card reader mode, audio signal of constant frequency and amplitude is not provided via earphone jack(160) of mobile(100).
Analog signal from contact type card reader unit(201) is provided to microphone jack(170) of mobile(100) through passive summing unit(295).

FIG. 12 shows an example of power supply unit(210) of card reader unit(200). Diode bridge(211) rectifies audio signal of constant frequency and amplitude provided via earphone jack(160) of mobile(100). The rectified audio signal is supplied to Zener diode(213) through current limit resister(212), then the voltage across the Zener diode(213) is charged into capacitor(214) into Vout, and supplied to each elements of card reader unit(200). A preferable frequency of audio signal provided via earphone jack(160) of mobile(100) can be selected between 100 Hz˜4 KHz, and amplitude can be set more than 10% of maximum amplitude of power generating module(120) used. For more precise power, voltage regulator circuit can be adopted, and voltage multiplier circuit can be used for power voltage higher than supplied audio signal.

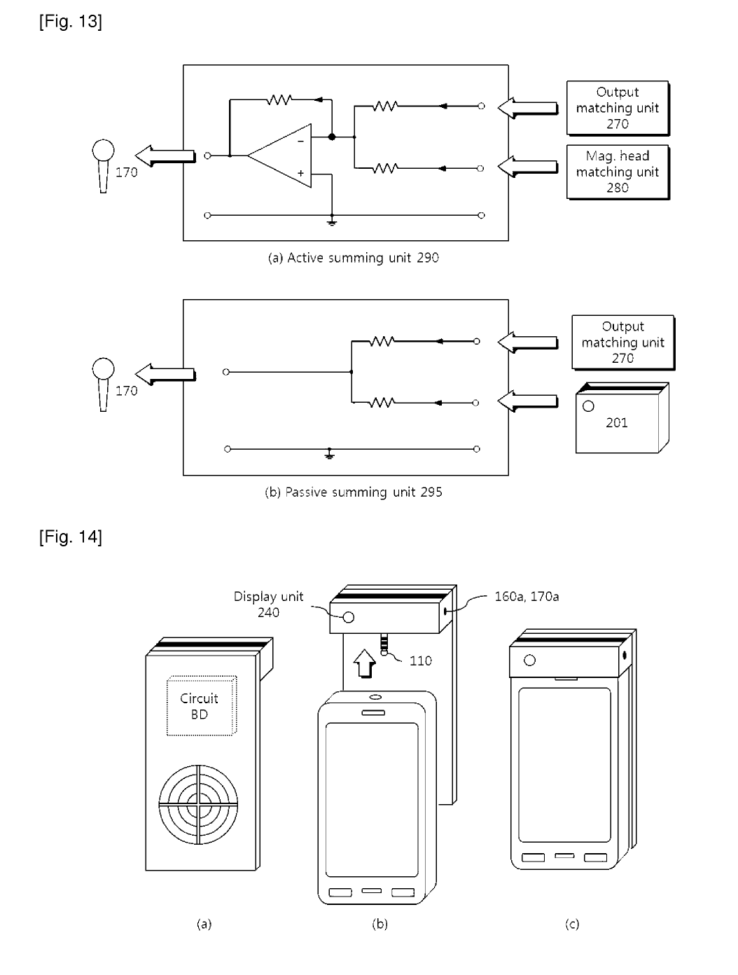

FIG. 13 shows examples of active summing unit(290) and passive summing unit(295) explained in FIGS. 9 and 10, respectively. Active summing unit(290) of figure (a) can be constructed with analog adder circuit to add data signals from output matching unit(270) and magnetic head matching unit(280).

Passive summing unit(295) can be formed with resisters to add signals from output matching unit(270) and contact type card reader unit(201). The passive summing unit(295) can provide read signal to microphone jack(170) of mobile(100) without applying audio signal to power supply unit(210) of card reader unit(200).

FIG. 14 shows an example of realized card reader device using a mobile of the present invention. The card reader device comprises contact type card reader unit(201), contactless type card reader unit(203), circuit board in a set as shown figure (a). The card reader device is connected to mobile via audio jack(110) as shown figure(b)(c), reads data from contact type card(202) and contactless type card(203), then provides read data to microphone input jack of mobile as read signals. The card reader device comprises display unit(240) to display operating status, and provides extended earphone jack(160a) and extended microphone jack(170a) for external audio connection.

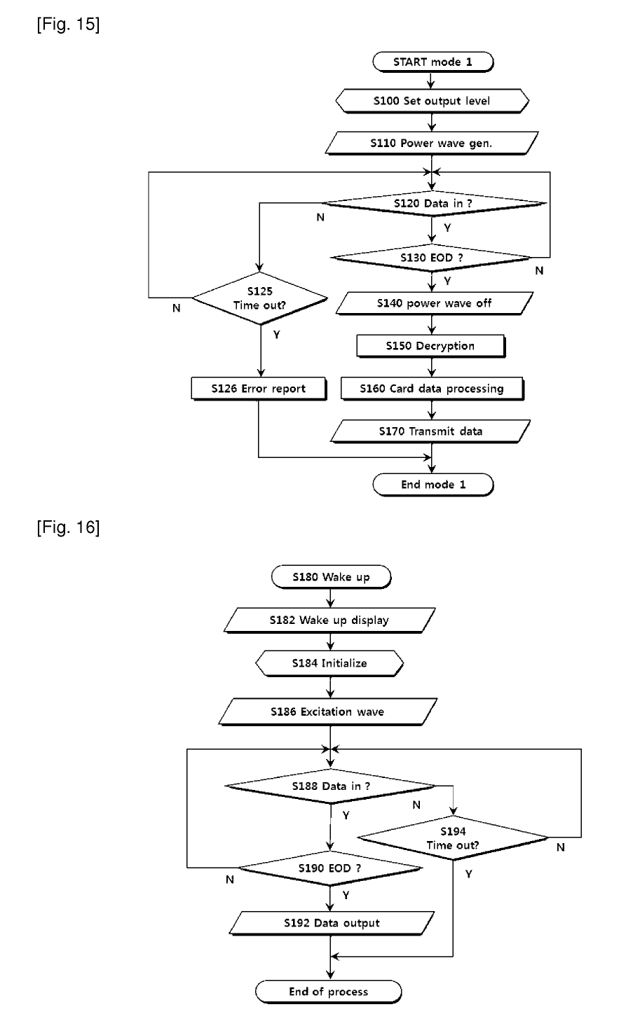

FIG. 15 is a flow chart of operating method for card reader device using a mobile of present invention. The flow chart shown in the figure specifies mobile side operation for contactless type card reader mode for the construction in FIG. 9 to FIG. 11.

(1) Contactless Type Card Reader Mode (Mobile Side)

a) Controller(107) of mobile(100) sets output frequency and level. (S100)

b) Controller(107) activates power generating module(120) to output audio wave through earphone jack(160).(S110)

c) Controller(107) activates A/D conversion unit and checks if A/D data of earphone jack(160) input is larger than noise level. (S120)

d) When A/D data of earphone jack(160) input is larger than noise level, controller(107) continues reading A/D data of earphone jack(160) input repeating (S120) till A/D data is not larger than noise level over time set.

e) After reading A/D data of earphone jack(160) input is finished, controller(107) de-activates power generating module(120) to quit to output audio wave through earphone jack(160). (S140)

f) Controller(107) extracts encrypted card data from read A/D data, and the encrypted card data is provided to decryption module(135) to be decrypted. (S150)

g) Controller(107) discriminates type (contact type or contactless type) of read card from the decrypted card data, and the decrypted card data is provided magnetic strip processing module(140) or contactless card data processing module(150) according to the type of card to convert processed card data into ISO standard format or transaction format specified by the service institute. (S160)

h) Controller(107) transmits data from magnetic strip processing module(140) or contactless card data processing module(150), to transaction service institute, then terminates process. (S170)
At the step, controller(107) checks if A/D data of earphone jack(160) input is larger than noise level(S120), when one of A/D data larger than noise level over a period set by clock timer(104) is detected, controller(107) reports error(S126) and set mobile(100) into initial state, then terminates process.

FIG. 16 is a flow chart of operating method for card reader device using a mobile of present invention. The flow chart shown in the figure specifies card reader side operation for the construction in FIG. 9 to FIG. 11.

(2) Contactless Type Card Reader Mode (Card Reader Unit Side)

a) Audio signal of constant frequency and amplitude is provided via earphone jack(160) of mobile(100) into power supply unit(210) of card reader unit(200), then reader controller(220) of card reader unit(200) wakes up.(S180)

b) Reader controller(220) of card reader unit(200) activates display unit(240) to display reader unit(200) is active, and turns off audio switch(165) to cut off extended earphone jack(160a) and extended microphone jack(170a) for external audio connection. (S182)

c) Reader controller(220) of card reader unit(200) activates excitation unit(250) to generate and provide exciting signal(203a) to antenna coil of contactless reader unit(203). (S186)

d) Reader controller(220) discriminates if data is supplied from level shifter(265). (S188)

e) When data is from level shifter(265), reader controller(220) repeats receiving data from level shifter(265) (S188), until end of data is detected. (S190)

f) When end of data is detected, reader controller(220) converts received data into data rate of voice signal band, outputs to microphone jack(170). (S192)
At the step, reader controller(220) of card reader unit(200) checks if data is supplied from level shifter(265) (S188), when none of data is supplied from level shifter(265) over a period set by watchdog timer(230) is detected, controller(107) terminates process. Reading process from the contact type card reader(201) is to be finished within the time set by watchdog timer(230) above.

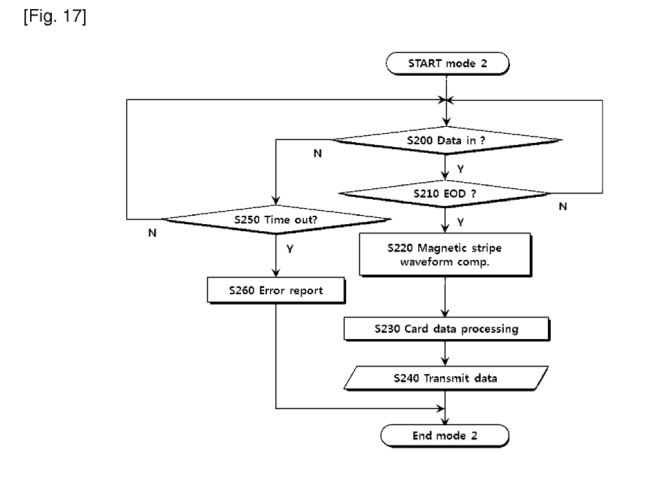

FIG. 17 is a flow chart of operating method for card reader device using a mobile of present invention. The flow chart shown in the figure specifies mobile side operation for the construction in FIG. 9 and FIG. 10.

(3) Contact Type Card Reader Passive Mode (Mobile Side)

In contact type card reader passive mode, audio signal of constant frequency and amplitude is not provided via earphone jack(160) of mobile(100).

a) Controller(107) of mobile(100) activates A/D conversion unit and checks if A/D data of earphone jack(160) input is larger than noise level. (S200)

b) When A/D data of earphone jack(160) input is larger than noise level, controller(107) continues reading A/D data of earphone jack(160) input repeating (S200) until A/D data is not larger than noise level over time set. (S210)

c) Controller(107) provides received A/D data to magnetic waveform compensation module(130), then extracts card data from the compensated A/D data.

d) Controller(107) provides extracted card data to magnetic strip processing module(140) to convert extracted card data into ISO standard format or transaction format specified by the service institute. (S230)

e) Controller(107) transmits data from magnetic strip processing module(140) to transaction service institute, then terminates process. (S240)
At the step, controller(107) checks if A/D data of earphone jack(160) input is larger than noise level(S200), when none of A/D data larger than noise level over a period set by clock timer(104) is detected, controller(107) reports error(S260) and set mobile(100) into initial state, then terminates process.

According to the present invention said above, mobile is arranged to supply electric power through audio output jack, and to transmit card data applied from the card reader device via microphone input jack. The card reader unit is connected to the audio jack of the mobile only, and offers card data read by the card reader units via microphone input of the mobile.

The foregoing exemplary embodiments and advantages are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

### INDUSTRIAL APPLICABILITY

Since the present invention offers advantageous effects to offer a card reader to process contact and contactless type cards, combined with mobiles without additional power units, can be applicable in the field of transaction service concerned with credit cards and debit cards, etc., including mobile application industries.

1. A card reader device comprising;
a mobile(100) providing audio signal as electric power through earphone output of audio jack(110), to transmit card data extracted from the signal offered by card reader unit(200) through microphone input of audio jack(110),
a card reader unit(200) connected to the audio jack(110) of mobile(100) while the card reader unit(200) comprises contact type card reader unit(201) to read contact type card(202) with magnetic strip, and contactless type card reader unit(203) to read contactless type cards such as IC cards, and
the said card reader unit(200) is powered by audio signal from the mobile(100), and card data read is transmitted via microphone input of audio jack(110).

2. A card reader device using a mobile comrising;
communication unit(101) to transmit and receive voice and data under the control of controller(107),
display unit(102) to display information and data provided from the controller(107),
touch screen control unit(103) prepared over display unit(102) and to provide touch screen input to the controller(107),
clock timer(104) counting time as set by the controller(107), D/A converting unit(105) converting voice or audio data received by communication unit(101) into analog signal, then provides to speaker unit inside of mobile(100) or external earphone jack(160) of audio jack, A/D converting unit(106) converting signals from microphone inside the mobile(100) or external microphone jack(170), into digital data to provide to the controller(107),
controller(107) executing program stored in the application module(108) to transmit data from A/D converting unit(106) via communication unit(101), or performs internal process,
application module(108) storing application programs for the mobile(100),
controller(107) executing program selected by user from the application module(108),
power generating module(120) to generate audio signal of constant frequency and amplitude and outputs via earphone jack(160) through D/A converting unit(105), under the control from the controller(107), magnetic waveform compensation module(130) to ompensate waveform, converted signal from the microphone jack(170) by A/D converting unit(106), into logic level data,
decryption module(135) to extract card data from the data from the microphone jack(170) by A/D converting unit(106), which is encrypted by card reader unit(200),
magnetic strip data processing module(140) to onvert contact type card data from magnetic waveform compensation module(130) or decryption module(135), into ISO standard format or that of card transaction service institute such as banks contactless card data processing module(150) to convert contactless type card data from decryption module(135), into ISO standard format or that of card transaction service institute such as banks, then to provide to controller(107).

3. A card reader device using a mobile wherin card reader unit is connected to mobile via audio jack with earphone jack and microphone jack comrising;
power supply unit(210) to convert audio signal of constant frequency and amplitude provided via earphone jack(160) of mobile(100) into dc power, and supplies to each elements of card reader unit(200), encryption unit(225) to encrypt card data provided from reader controller(220) of card reader unit(200),
watchdog timer(230) to count time set by reader controller(220), display unit(240) to displays operation status of card reader unit(200), excitation unit(250) to generate and provide exciting signal(203a) to antenna coil of contactless reader unit(203), under the control of reader controller(220),
demodulation unit(260) to demodulate data carrier signal(203b) received by antenna of contactless type card reader(203), which is transmitted from contactless type card(204) excited by excitation signal(203a) from excitation unit(250),
level shifter(265) to change input analog signal into logic level output to be read by reader controller(220),
output matching unit(270) to attenuate data signal from reader controller(220) to provide to microphone jack(170) of mobile(100), magnetic head matching unit(280) to attenuate or amplify level of signal from contact type card reader unit(201) to provide it to microphone jack(170) of mobile(100),
active summing unit(290) to add signals from output matching unit(270) and magnetic head matching unit(280), to provide added signals to microphone jack(170) of mobile(100).

4. A card reader device as claimed in claim 3 wherein, the watchdog timer(230) is referred by reader controller(220) to process error or to end process, when card data is not read within the time set for reading a card.

5. A card reader device as claimed in claim 3 wherein, card reader unit(200) more comprises audio switch(165) with earphone jack(160) and microphone jack(170) inputs, and extended earphone jack(160a) and extended microphone jack(170a) outputs, to be operated when card reader unit(200) is not operating as card reader, reader controller(220) connects earphone jack(160) to extended earphone jack(160a) and microphone jack(170) to extended microphone jack(170a) through audio switch(165),
while when card reader unit(200) is operating as card reader, reader controller(220) disconnects extended earphone jack(160a) from earphone jack(160) and extended microphone jack(170a) from microphone jack(170) through audio switch(165).

6. A card reader device using a mobile wherin the signal from magnetic head of contact type card reader unit(201) is directly connected to passive summing unit(295), and the passive summing unit(295) adds the read signal from contact type card reader unit(201) and the signal from output matching unit comrising;
power supply unit(210) to convert audio signal of constant frequency and amplitude provided via earphone jack(160) of mobile(100) into dc power, and supplies to each elements of card reader unit(200), only when to read
contactless card(204),
encryption unit(225) to encrypt card data provided from reader controller(220) of card reader unit(200) when to read contactless card(204) only,
watchdog timer(230) to count time set by reader controller(220), display unit(240) to display operation status of card reader unit(200), excitation unit(250)to generate and provide exciting signal(203a) to antenna coil of contactless reader unit(203), under the control of reader controller(220),
demodulation unit(260) to emodulate data carrier signal(203b) received by antenna of contactless type card reader(203), which is transmitted from contactless type card(204) excited by excitation signal(203a) from excitation unit(250),
level shifter(265) to change input analog signal into logic level output to be read by reader controller(220),
output matching unit(270) to attenuate data signal from reader controller(220) to provide to microphone jack(170) of mobile(100), passive summing unit(295) to add signals from output matching unit(270) and contact type card reader unit(201), to provide added signals to microphone jack(170) of mobile(100).

7. A card reader device as claimed in claim 6 wherein, card reader unit(200) more comprises audio switch(165) with earphone jack(160) and microphone jack(170) inputs, and extended earphone jack(160a) and extended microphone jack(170a) outputs, to be operated when card reader unit(200) is not operating as card reader, reader controller(220) connects earphone jack(160) to extended earphone jack(160a) and microphone jack(170) to extended microphone jack(170a) through audio switch(165),
while when card reader unit(200) is operating as card reader, reader controller(220) disconnects extended earphone jack(160a) from earphone jack(160) and extended microphone jack(170a) from microphone jack(170) through audio switch(165).

8. A card reader device using a mobile wherin the signal from magnetic head of contact type card reader unit(201) is directly connected to level shifter(265), and output from card reader unit(200) is provided to microphone jack(170) of mobile(100) via output matching unit(270) comrising;
power supply unit(210) to convert audio signal of constant frequency and amplitude provided via earphone jack(160) of mobile(100) into dc power, and to suppliy to each elements of card reader unit(200), encryption unit(225) to encrypt card data provided from reader controller(220) of card reader unit(200) when to read both of contactless type card(204) and contact type card(202),
watchdog timer(230) to count time set by reader controller(220), display unit(240) to display operation status of card reader unit(200), excitation unit(250) to generate and provide exciting signal(203a) to antenna coil of contactless reader unit(203) for contactless type card(204), under the control of reader controller(220),
demodulation unit(260) demodulates data carrier signal(203b) received by antenna of contactless type card reader(203), which is transmitted from contactless type card(204) excited by excitation signal(203a) from excitation unit(250),
level shifter(265) to change input analog signal into logic level output to be read by reader controller(220),
output matching unit(270) basically attenuates data signal from reader controller(220) to provide to microphone jack(170) of mobile(100).

9. A card reader device as claimed in claim 8 wherein, card reader unit(200) more comprises audio switch(165) with earphone jack(160) and microphone jack(170) inputs, and extended earphone jack(160a) and extended microphone jack(170a) outputs, to be operated when card reader unit(200) is not operating as card reader, reader controller(220) connects earphone jack(160) to extended earphone jack(160a) and microphone jack(170) to extended microphone jack(170a) through audio switch(165), while when card reader unit(200) is operating as card reader, reader controller(220) disconnects extended earphone jack(160a) from earphone jack(160) and extended microphone jack(170a) from microphone jack(170) through audio switch(165).

10. A card reader device as claimed in one of claims 2, 3, 6, 8 wherein,
audio signal of constant frequency and amplitude is provided via earphone jack(160) of mobile(100) into power supply unit(210) of card reader unit(200). The power supply unit(210) converts the audio signal into dc power, and supplies to each elements of card reader unit(200),
reader controller(220) activates excitation unit(250) to generate and to provide exciting signal(203a) to antenna coil of contactless reader unit(203),
demodulation unit(260) demodulates data carrier signal(203b) received by antenna of contactless type card reader(203), which is transmitted from contactless type card(204) excited by excitation signal(203a) from excitation unit(250),
level shifter(265) changes input analog signal from demodulation unit(260) into logic level output to be read by reader controller(220),
reader controller(220) encrypts card data provided from level shifter(265) through encryption unit(225),
reader controller(220) provides encrypted card data to output matching unit(270) as read data signal to microphone jack(170) of mobile(100)—in this case, the data rate of the said encrypted card data is lowered to voice frequency by reader controller(220),
output matching unit(270) attenuates encrypted card data signal from reader controller(220) to provide to microphone jack(170) of mobile(100).

11. A card reader device as claimed in claim 10 wherin;
the output of said output matching unit(270) is provided to microphone jack(170) of mobile(100) in one of following ways;
the signal from said output matching unit(270) is provided to active summing unit(290), and then provided to microphone jack(170) of mobile(100).
the signal from said output matching unit(270) is provided to passive summing unit(295), and then provided to microphone jack(170) of mobile(100).
the signal from said output matching unit(270) is directly provided to microphone jack(170) of mobile(100).

12. A card reader device as claimed in one of claims 2, 3, 6, 8 wherein,
audio signal of constant frequency and amplitude is provided via earphone jack(160) of mobile(100) into power supply unit(210) of card reader unit(200), and the power supply unit(210) converts the audio signal into dc power, and supplies to each elements of card reader unit(200),
magnetic head matching unit(280) attenuates or amplifies level of signal from contact type card reader unit(201) to provide to microphone jack(170) of mobile(100),
active summing unit(290) provides signal from magnetic head matching
unit(280) to microphone jack(170) of mobile(100).

13. A card reader device as claimed in one of claims 2, 3, 6, 8 wherein,
Audio signal of constant frequency and amplitude is provided via earphone jack(160) of mobile(100) into power supply unit(210) of card reader unit(200), and the power supply unit(210) converts the audio signal into dc power, and supplies to each elements of card reader unit(200),
level shifter(265) changes input analog signal from contact type card reader unit(201) into logic level output to be read by reader controller(220),
reader controller(220) encrypts card data provided from level shifter(265) through encryption unit(225),
reader controller(220) provides encrypted card data to output matching unit(270) as read data signal to microphone jack(170) of mobile(100).

14. A card reader device as claimed in one of claims 2, 3, 6, 8 wherein,
audio signal of constant frequency and amplitude is not provided via earphone jack(160) of mobile(100),
analog signal from contact type card reader unit(201) is provided to microphone jack(170) of mobile(100) through passive summing unit(295).

15. Method of operating card reader device using a mobile comprising the steps of;
a) Controller(107) of mobile(100) sets output frequency and level; (S100)
b) Controller(107) activates power generating module(120) to output audio wave through earphone jack(160);(S110)
c) Controller(107) activates A/D conversion unit and checks if A/D data of earphone jack(160) input is larger than noise level;(S120)
d) When A/D data of earphone jack(160) input is larger than noise level, controller(107) continues reading A/D data of earphone jack(160) input repeating (S120) till A/D data is not larger than noise level over time set.
e) After reading A/D data of earphone jack(160) input is finished, controller(107) deactivates power generating module(120) to quit to output audio wave through earphone jack(160);(S140)
f) Controller(107) extracts encrypted card data from read A/D data, and the encrypted card data is provided to decryption module(135) to be decrypted;(S150)
g) Controller(107) discriminates type (contact type or contactless type) of read card from the decrypted card data, and the decrypted card data is provided magnetic strip processing module(140) or contactless card data processing module(150) according to the type of card to convert processed card data into ISO standard format or transaction format specified by the service institute;(S160)
h) Controller(107) transmits data from magnetic strip processing module(140) or contactless card data processing module(150), to transaction service institute, then terminates process;(S170)

16. The method as claimed in claim 15 wherein;
at the step controller(107) checks if A/D data of earphone jack(160) input is larger than noise level(S120),
when one of A/D data larger than noise level over a period set by clock timer(104) is detected, controller(107) reports error(S126) and set mobile(100) into initial state, then terminates process.

17. Method of operating card reader device using a mobile comprising the steps of;
a) Audio signal of constant frequency and amplitude is provided via earphone jack(160) of mobile(100) into power supply unit(210) of card reader unit(200), then reader controller(220) of card reader unit(200) wakes up;(S180)
b) Reader controller(220) of card reader unit(200) activates display unit(240) to display reader unit(200) is active, and turns off audio switch(165) to cut off extended earphone jack(160a) and extended microphone jack(170a) for external audio connection;(S182)
c) Reader controller(220) of card reader unit(200) activates excitation unit(250) to generate and provide exciting signal(203a) to antenna coil of contactless reader unit(203);(S186)
d) Reader controller(220) discriminates if data is supplied from level shifter(265); (S188)
e) When data is from level shifter(265), reader controller(220) repeats receiving data from level shifter(265) (S188), until end of data is detected ;(S190)
f) When end of data is detected, reader controller(220) converts received data into data rate of voice signal band, outputs to microphone jack(170); (S192)

18. The method as claimed in claim 17 wherein;
at the step reader controller(220) of card reader unit(200) checks if data is supplied from level shifter(265) (S188), when none of data is supplied from level shifter(265) over a period set by watchdog timer(230) is detected, controller(107) terminates process.

19. 9] Method of operating card reader device using a mobile comprising the steps of;
a) Controller(107) of mobile(100) activates A/D conversion unit and checks if A/D data of earphone jack(160) input is larger than noise level; (S200)
b) When A/D data of earphone jack(160) input is larger than noise level, controller(107) continues reading A/D data of earphone jack(160) input repeating (S200) until A/D data is not larger than noise level over time set; (S210)
c) Controller(107) provides received A/D data to magnetic waveform compensation module(130), then extracts card data from the compensated A/D data,
d) Controller(107) provides extracted card data to magnetic strip processing module(140) to convert extracted card data into ISO standard format or transaction format specified by the service institute;(S230)
e) Controller(107) transmits data from magnetic strip processing module(140) to transaction service institute, then terminates process;(S240).

20. The method as claimed in claim 19 wherein;
at the step, controller(107) checks if A/D data of earphone jack(160) input is larger than noise level(S200),
when none of A/D data larger than noise level over a period set by clock timer(104) is detected,
controller(107) reports error(S260) and set mobile(100) into initial state, then terminates process.
